(19) United States
(12) Patent Application Publication
(10) Pub. No.: US 2012/0033600 A1
(43) Pub. Date: Feb. 9, 2012

(54) METHOD AND APPARATUS FOR PROVIDING MULTICAST SERVICE FOR MOBILE NODE IN MOBILE COMMUNICATION SYSTEM

(75) Inventors: Seng-Kyoun JO, Chungbuk (KR); Eun-Jun RHEE, Daejeon (KR); Il-Gu JUNG, Daejeon (KR); Sung-Kuen LEE, Gyeonggi-do (KR); Kyoung-Hee LEE, Daejeon (KR); Hyun-Woo LEE, Daejeon (KR); Won RYU, Daejeon (KR)

(73) Assignee: Electronics and Telecommunications Research Institute, Daejeon (KR)

(21) Appl. No.: 13/187,084

(22) Filed: Jul. 20, 2011

(30) Foreign Application Priority Data
Jul. 20, 2010 (KR) 10-2010-0070037

(51) Int. Cl. H04W 4/06

(52) U.S. Cl. 370/312

(57) ABSTRACT

A method for providing a multicast service for an MN includes: transmitting, by an MN connected to a first access point within a first access network, multicast information of the MN to an agent of the first access network through the first access point, wherein the multicast information includes information on a multicast source and a multicast group; transmitting and receiving messages between agents according to a predetermined protocol based on the multicast information of the MN transmitted to the agent of the first access network, and setting a multicast path between the multicast source and the MN of the first access network between the agents; transmitting, by the agent of the first access network, the multicast information of the MN to the MICS; and registering, by the MICS, the multicast information of the MN transmitted from the agent of the first network.

### CROSS-REFERENCE TO RELATED APPLICATIONS

The present application claims priority of Korean Patent Application No. 10-2010-0070037, filed on Jul. 20, 2010, which is incorporated herein by reference in its entirety.

### BACKGROUND OF THE INVENTION

1. Field of the Invention

Exemplary embodiments of the present invention relate to an apparatus and method for providing a multicast service for a mobile node in a mobile communication system; and, more particularly, to technology for supporting a constant multicast service even during a handover between heterogeneous networks, using network-based mobility management technology.

2. Description of Related Art

Unicasting technology is to transmit data to one receiver, and broadcasting technology is to transmit data to all receivers within a network. However, multicasting technology is characterized in that it transmits data to limited receivers having joined a group. FIG. 1 illustrates the unicasting method, and FIG. 2 illustrates the multicasting method. Referring to FIGS. 1 and 2, a method in which a source 10 transmits data to a plurality of receivers 21, 22, and 23 will be described. In the case of the unicasting method as illustrated in FIG. 1, an overhead of duplicate transmissions corresponding to the number of receivers 21 to 23 occurs in the source 10. In the case of the IP multicasting as illustrated in FIG. 2, however, when a multicast source 10 transmits one data packet, the network copies the data packet by the number of receivers, and transmits the copied data packets. In other words, routers 30 route the corresponding data packet such that the data packet is transmitted to subscribers having joined the multicast group, and copy the corresponding data packet by the required number. Therefore, it is possible to reduce the overhead of transmissions corresponding to the number of receivers. Furthermore, since a plurality of packets do not need to be transmitted across the network, it is possible to reduce a bandwidth.

Recently, a variety of application services using the multicasting method have been provided. Furthermore, as mobile terminals including smart phones quickly develop, the range of the services has expanded into services oriented to mobile hosts instead of fixed hosts as the multicast receivers. Since such the mobile hosts may move from one network to another network, a method capable of properly processing a handover is additionally required in the existing multicast technology for fixed hosts.

### SUMMARY OF THE INVENTION

An embodiment of the present invention is directed to an apparatus and method for providing a multicast service for an MN, which is capable of providing a constant multicast service by minimizing a processing delay time occurring during a handover of an MN.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, there is provided a method for providing a multicast service for an MN in a mobile communication system including a plurality of access networks, a plurality of agents for the respective access networks which connect a core network unifying the access networks, and a mobility information control server (MICS) positioned in the core network and configured to manage the plurality of access network. The method includes: transmitting, by an MN connected to a first access point within a first access network, multicast information of the MN to an agent of the first access network through the first access point, wherein the multicast information includes information on a multicast source and a multicast group; transmitting and receiving messages between agents according to a predetermined protocol based on the multicast information of the MN transmitted to the agent of the first access network, and setting a multicast path between the multicast source and the MN of the first access network between the agents; transmitting, by the agent of the first access network, the multicast information of the MN to the MICS; and registering, by the MICS, the multicast information of the MN transmitted from the agent of the first network.

In accordance with another embodiment of the present invention, there is provided a method for providing a multicast service for an MN in a mobile communication system including a plurality of access networks, a plurality of agents for the respective access networks which connect a core network unifying the access networks, and an MICS positioned in the core network and configured to manage the plurality of access networks. The method includes: receiving multicast information of an MN, which is transmitted from the MN connected to a first access point within a first access network through the first access point to an agent of the first access network, from the agent of the first access network, wherein the multicast information includes information on a multicast source and a multicast group; registering the multicast information of the MN received from the agent of the first access network; when the MN moves from the first access network to a second access network, receiving position information of the MN, which is transmitted to an agent of the second access network from a second access point of the second access network to which the MN is connected, and an address of the agent of the second access network from the agent of the second access network; updating previously-registered position information of the MN using the position information of the MN and the address of the agent of the second access network, which are received from the agent of the second access network, and extracting the registered multicast information of the MN; and transmitting and receiving messages between the agents according to a predetermined protocol based on the extracted multicast information of the MN, and transmitting the extracted multicast information of the MN to the agent of the second access network to reset a multicast path between the multicast source and the MN having moved to the second access network.

In accordance with another embodiment of the present invention, there is provided an agent of any one access network for providing a multicast service to an MN in a mobile communication system including a plurality of access networks, a plurality of agents for the respective access networks which connect a core network unifying the access networks, and an MICS positioned in the core network and configured to manage the plurality of access networks. The agent includes: a reception unit configured to receive multicast information of an MN connected to an access point within the access network through the access point from the MN, wherein the multicast information includes information on a multicast source and a multicast group; a management unit configured to set a multicast path between the multicast source and the MN of the access network between agents, through transmission and reception of messages between the agents according to a predetermined protocol based on the received multicast information of the MN; and a transmission unit configured to transmit the multicast information of the MN to the MICS such that the multicast information is registered in the MICS. The transmission unit transmits one or more messages, which are required for setting the multicast path between the agents through the MICS, to another or more agents, and the reception unit receives one or more messages, which are required for setting the multicast path between the agents through the MICS, from another or more agents.

In accordance with another embodiment of the present invention, there is provided an MICS providing a multicast service to an MN in a mobile communication system including a plurality of access networks, a plurality of agents for the respective access networks which connect a core network unifying the access networks, and the MICS positioned in the core network and configured to manage the plurality of access networks. The MICS includes: a reception unit configured to receive multicast information of an MN, which is transmitted from the MN connected to a first access point within a first access network through the first access point to an agent of the first access network, from the agent of the first access network, wherein the multicast information includes information on a multicast source and a multicast group; a central management unit configured to register the multicast information of the MN received from the agent of the first access network; and a transmission unit. When the MN moves from the first access network to a second access network, the reception unit receives position information of the MN, which is transmitted to an agent of the second access network from a second access point of the second access network to which the MN is connected, and an address of the agent of the second access network from the agent of the second network, the central management unit updates previously-registered position information of the MN and extracts the registered multicast information of the MN, using the position information of the MN and the address of the agent of the second access network which are received from the agent of the second access network, and the transmission unit transmits the extracted multicast information of the MN to the agent of the second access network such that a multicast path between the multicast source and the MN having moved to the second access network is reset between the agents, through transmission and reception of messages between the agents according to a predetermined protocol based on the extracted multicast information of the MN.

### BRIEF DESCRIPTION OF THE DRAWINGS

FIG. 1 illustrates a unicasting method.

FIG. 2 illustrates a multicasting method.

FIG. 3 is a diagram illustrating the configuration of a mobile communication system in accordance with an embodiment of the present invention.

FIG. 4 is a diagram illustrating a multicast group joining procedure in accordance with the embodiment of the present invention.

FIG. 5 is a diagram explaining an initial registration process of a node in accordance with the embodiment of the present invention.

FIG. 6 is a diagram illustrating the structure of a table for an MN which is managed by an MICS in accordance with the embodiment of the present invention.

FIG. 7 is a diagram explaining a multicast group rejoining procedure during a handover in accordance with the embodiment of the present invention.

FIG. 8 is a diagram explaining a multicast group cancellation procedure in a previous network during a handover in accordance with the embodiment of the present invention.

FIG. 9 is a diagram illustrating the configuration of an agent in an access network in accordance with the embodiment of the present invention.

FIG. 10 is a diagram illustrating the configuration of an MICS in accordance with the embodiment of the present invention.

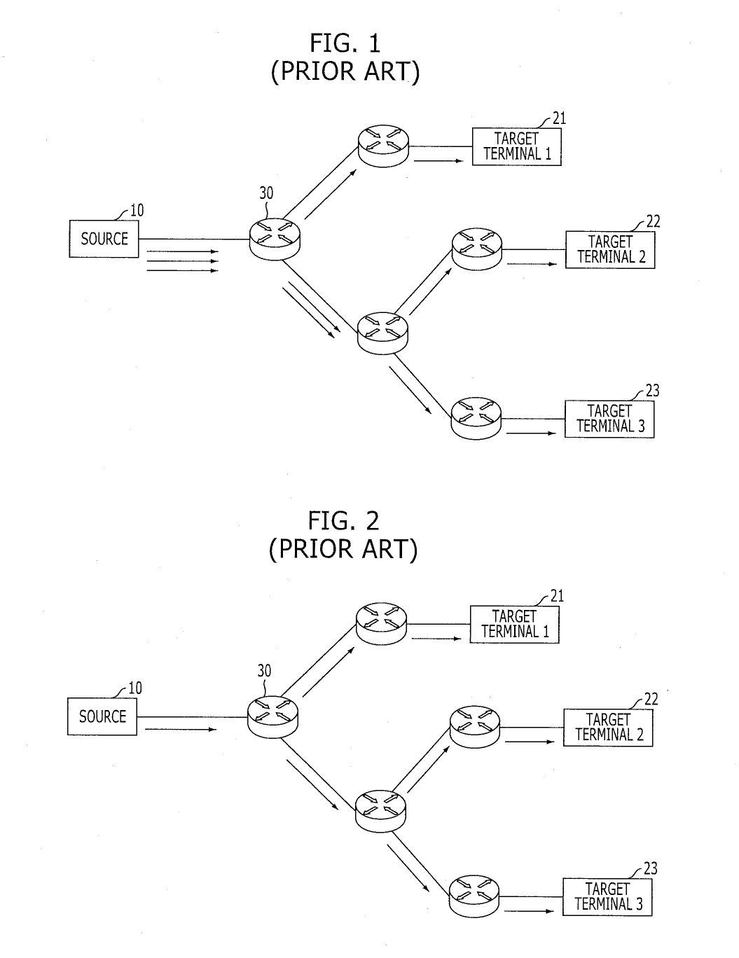

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

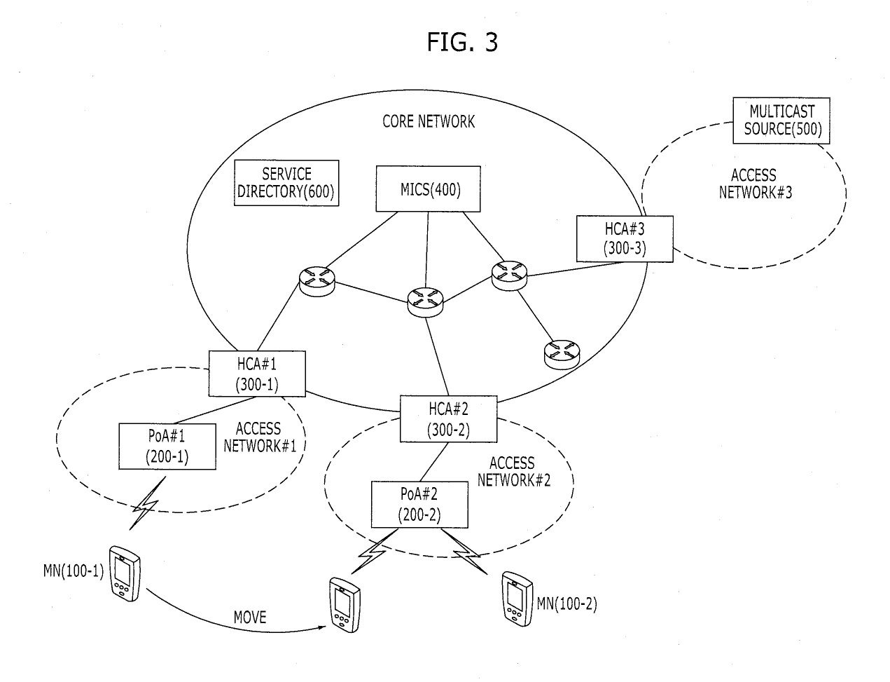

Referring to FIG. 3, the configuration of a mobile communication system in accordance with an embodiment of the present invention will be described.

A point of attachment (hereinafter, referred to as ‘PoA’) 200 is a point which a mobile node (MN) 100 accesses in a wireless network, and also referred to as an access point (AP). The PoA 200 may communicate with a network access equipment which connects an access network to a core network. In this specification, the network access equipment is a mobility supporting device for a node, and hereinafter referred to as a handover control agent (HCA) 300. The PoA 200 extracts a layer-2 (L2) address for the MN 100 through an L2 connection process to the MN 100, and transmits the extracted L2 address to the HCA 300 in a local region.

The HCA 300 positioned at an edge of the core network manages information on permanent addresses (PAs), L2 addresses, and local addresses (LAs) for nodes belonging to a lower management region of the HCA 300 and an interface to a PoA around which the nodes are positioned. For example, the information may be managed by a local node address management table (LNAT) of Table 1. The PA refers to an IP address which is not changed even when a node is handed over to another access network, and the LA refers to an effective address within the corresponding access network.

TABLE 1

| | | | | |
|---|---|---|---|---|
| L2 address | PA | LA of node | Interface to PoA | Additional |
| of node | of node | | where node is | option |
| (MAC address) | | | positioned | region |

Furthermore, the HCA 300 manages information on PAs of correspondent nodes with which nodes positioned within an access network managed by the HCA 300 are to communicate, an L3 address of an HCA where the correspondent nodes are positioned, and a tunnel interface address to the HCA where the correspondent nodes are positioned. For example, the information may be managed by a correspondent node address management table (CNAT) of Table 2.

TABLE 2

| | | | |
|---|---|---|---|
| PA of | L3 address of HCA | Tunnel interface | Additional |
| correspondent | where correspondent | to HCA where | option region |
| node | node is positioned | correspondent node | |
| | | is positioned | |

Furthermore, the HCA 300 performs an encapsulation and decapsulation function for data packets. For example, an HCA#1 300-1 encapsulates a data packet transmitted from an MN 100-1 and transmits the encapsulated data packet to a correspondent node 100-2. Furthermore, the HCA#1 300-1 decapsulates a data packet transmitted from the correspondent node 100-2 and transmits the decapsulated data packet to the MN 100-1.

Meanwhile, a mobility information control server (MICS) 400 positioned in the core network serves to perform position management for nodes, and may be mounted in a high-performance server, a router, or a switch existing in the core network. The MICS 400 in accordance with the embodiment of the present invention receives information on L2 addresses, PAs, and LAs of nodes and information on L3 addresses of the HCAs 300 from the HCAs 300, and manages the information. For example, the information may be managed by a global location management table (GLMT) of Table 3.

TABLE 3

| | | | | |
|---|---|---|---|---|
| L2 address of | PA | LA of node | L3 address of HCA | Additional |
| node (MAC | of node | | where node is | option |
| address) | | | positioned | region |

Furthermore, the MICS 400 may manage information on communication connections between nodes. For example, the information may be managed by a communicating node mapping table (CNMT) of Table 4.

TABLE 4

| | | | | | |
|---|---|---|---|---|---|
| PA of | PA of | PA of | PA of | . . . | PA of |
| MN | correspondent | correspondent | correspondent | | corre- |
| | node 1 | node 2 | node 2 | | spondent |
| | | | | | node 2 |

The MICS 400 managing the GLMT and the CNMT provides the information to the HCAs 300.

Referring to FIG. 3, one or more dynamic or predetermined control channels may be set between the MICS 400 and the HCAs 300, directly or through one or more routers. The control channels may be used for traffic for processing the mobility of nodes in accordance with the embodiment of the present invention. When multiprotocol label switching (MPLS) technology is applied to the core network, a label switched path (LSP) may be set between the MICS 400 and the HCAs 300 and used as control channels for transmitting and receiving mobility signaling messages.

The multicast source 500 refers to a node which multicasts a data packet to nodes having joined a multicast group to which the multicast source 500 provides a multicast service. The multicast source 500 may be connected to an HCA#3 300-3 in a wired manner or connected wirelessly through a PoA.

A service directory 600 serves to manage information on available services in the mobile communication service, for example, a service list and provide the service information to nodes. The available service information may be provided in the form of electronic program guide (EPG). The service directory 600 may be implemented in various forms such as a HTTP-based web server and so on. In FIG. 3, the service directory 600 is positioned within the core network, but is not limited thereto. For example, the service directory 600 may provide the service information to the MN 100-1 through the HCA#1 300-1 and the PoA#1 200-1. At this time, the service directory 600 may be connected through one or more routers or directly to the HCA#1 300-1.

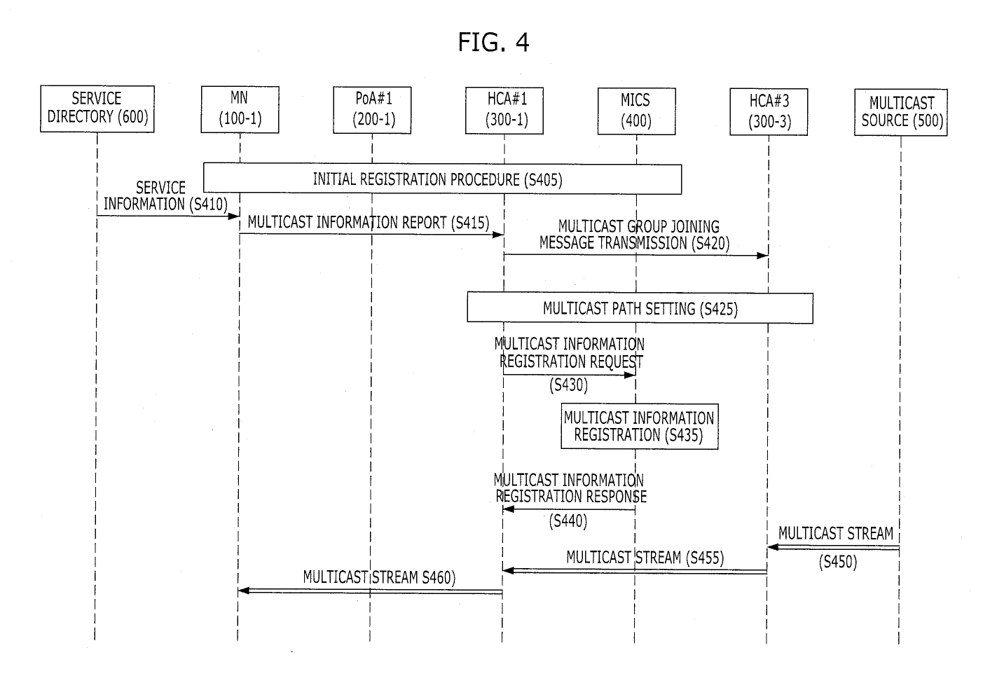

A node may select a desired service based on the information of services provided by the service directory 600. For example, when the node selects a multicast service, a procedure where the node joins a multicast group is performed as shown in FIG. 4.

In FIG. 3, the HCAs 300 and routers connecting the MICS 400 to the HCAs 300 perform a multicast routing function according to a predetermined protocol.

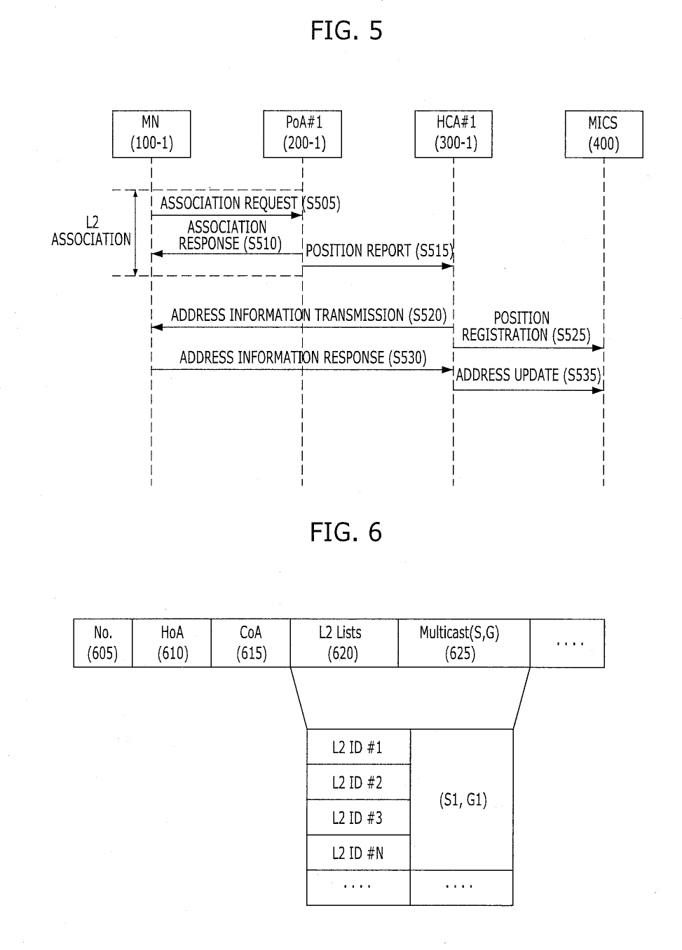

Referring to FIG. 4, the MN 100-1 connected to the mobile communication system through an initial registration procedure S405 joins a multicast group through subsequent procedures. First, the initial registration procedure 5405 in a case where the MN 100-1 is first connected to an access network connected to the core network will be described with reference to FIG. 5. Such a procedure indicates an initial setting process based on a loss of information related to the MN 100-1, because the MN 100-1 is not connected to the access network for communication for a long time.

When the MN 100-1 enters an access network #1, an L2 association process for setting a wireless channel with the PoA#1 200-1 is performed. During the L2 association process, the PoA#1 200-1 receiving an L2 association request from the MN 100-1 transmits an association response to the MN-1, while securing an L2 address as position information of the MN 100-1 through an L2 trigger function, at steps S505 and S510. Then, the PoA#1 200-1 transmits the L2 address of the MN 100-1 to the HCA#1 300-1 to which the PoA#1 200-1 belongs, using a position report message, at step S515. Here, the steps S510 and S515 may be performed at the same time. The L2 address may include ‘Ethernet 48-bit MAC address’, ‘3GPP2 international mobile station identity and connection ID’, ‘3GPP international mobile subscriber identity’, or ‘64-bit global ID, EUI-64’. Furthermore, the L2 association means that a wireless channel is formed between a node and a PoA through an L2 protocol, that is, a wireless MAC protocol such as IEEE 802.11. While a wireless MAC protocol or the like is exchanged between the node and the PoA, the PoA secures an L2 address such a MAC address of the node.

The HCA#1 300-1 stores the L2 address of the MN 100-1 included in the position report message. For example, the L2 address may be stored in the LNAT of Table 1. Depending on cases, the HCA#1 300-1 may generate an LA (L3 address) which is effective in its management region, and store the generated LA by mapping the LA to the L2 address of the MN 100-1 (for example, the LNAT of Table 1). Furthermore, the HCA#1 300-1 transmits a position registration message including the L2 address and LA of the MN 100-1 and the L3 address of the HCA#1 300-1 to the MICS 400, at step S525. Here, the L3 address of the HCA may include an IPv4 or IPv6 address. The MICS 400 receives the position registration message transmitted from the HCA#1 300-1, generates a record for the MN 100-1 in the GLMT of Table 3, and writes the L2 address and LA of the MN 100-1 and the L3 address of the HCA#1 300-1, which are included in the position registration message, into the corresponding record.

Meanwhile, the HCA#1 300-1 transmits the L3 address of the HCA#1 300-1 to the MN 100-1 using an address information message, and may simultaneously transmit an LA which is to be used by the MN 100-1, depending on cases, at step S520. Here, the LA refers to a temporary L3 address (for example, IP address) which may be used by the MN 100-1 in the access network #1. When the HCA#1 300-1 includes a lot of management target nodes, it may be difficult for the HCA#1 300-1 to check the paths of the accessing nodes. In this case, the HCA#1 300-1 may generate an LA which is to be used by the MN 100-1 in the access network #1 and allocate the generated LA to the MN 100-1. Therefore, the HCA#1 300-1 may easily manage the accessing nodes. Accordingly, in a network environment requiring such management, the process in which the HCA#1 300-1 generates and allocates an LA may be implemented.

The MN 100-1 receives the address information message, and changes its default gateway address into the L3 address of the HCA#1 300-1 included in the message. Accordingly, the MN 100-1 may transmit data packets using the default gateway address. Furthermore, the MN 100-1 transmits an address information response message to the HCA#1 300-1 in response to the address information message and informs the HCA#1 300-1 of the response. In this case, the MN 100-1 contains its PA information in the address information response message and then informs the HCA#1 300-1 of the PA information, at step S530. The HCA#1 300-1 receives the address information response message transmitted from the MN 100-1, extracts the PA of the MN 100-1 included in the message, and writes the extracted PA into the corresponding record of the LNAT of Table 1. Then, the HCA#1 300-1 informs the MICS 400 of the PA of the MN 100-1 through an address update message at step S535. The MICS 400 receives the address update message transmitted from the HCA#1 300-1, extracts the PA of the MN 100-1 included in the message, and writes the extracted PA into the corresponding record of the GLMT of Table 3. Through the above-described process, the initial registration procedure of the MN 100-1 is completed.

Hereinafter, referring to FIG. 4, a multicast group joining procedure in accordance with the embodiment of the present invention will be described. In this embodiment of the present invention, a variety of protocols may be applied. For example, based on IPv4, an Internet group management protocol (IGMP) v3 may be used in a node, and a protocol independent multicast-source specific multicast (PIM-SSM) protocol for forming a path may be used between multicast routers.

The MN 100-1 connected to the mobile communication system through the initial registration procedure 5405 receives information on services available in the mobile communication system from the service directory 600, at step S410. The service information may be directly provided in the form of an EPG to the MN 100-1 or indirectly provided from an application.

The MN 100-1 selects a desired service from the service information received from the service directory 600. When the MN 100-1 selects a multicast service, the MN 100-1 transmits information of the selected multicast service (hereinafter, referred to as ‘multicast information’) to the HCA#1 300-1 through the PoA#1 200-1 at step S415. Here, the multicast information includes a multicast source S and a multicast group G. For example, the MN 100-1 transmits the multicast information S and G to the HCA#1 300-1 positioned in the access network of the MN 100-1, using a report message defined in the IGMPv3.

By transmitting and receiving messages between agents according to a predetermined protocol based on the multicast information S and G transmitted to the HCA#1 300-1, a multicast path between the multicast source 500 and the MN 100-1 is set between the agents, at steps S420 and S425. In other words, the HCA#1 300-1 receiving the multicast information S and G of the MN 100-1 transmits a multicast group joining message based on the multicast information S and G of the MN 100-1 to an adjacent HCA, and an optimal path is set between the corresponding HCAs according to a predetermined algorithm. At this time, the HCA receiving the multicast group joining message from the HCA#1 300-1 according to a predetermined protocol may transmit a multicast group joining message to another adjacent HCA, like the HCA#1 300-1. Here, the HCAs may transmit and receive messages and set a path therebetween, directly or through one or more routers. For example, the HCA#1 300-1 transmits a PIM-SSM subscribe message including the multicast information of the MN 100-1 to the adjacent HCA at the step S420, and an optimal path is set between the corresponding HCAs according to an algorithm defined by the PIM protocol, at the step S425. The multicast path may be set in a tree type with the multicast source 500 set to a root.

Furthermore, the HCA#1 300-1 transmits the multicast information S and G of the MN 100-1 to the MICS 400 at step S430, and the MICS 400 stores the received multicast information S and G of the MN 100-1 at step S435. Accordingly, when the information of the MN is requested, the MICS 400 may provide the multicast information as well as the position information. During the step S430, the HCA#1 300-1 may transmit an identifier of the MN 100-1 together with the corresponding multicast information S and G, in order to notify that the corresponding multicast information is the multicast information S and G of the MN 100-1. This is not limited to the step S430. Furthermore, the steps S420 and S430 may be performed in parallel. Then, the MICS 400 may respond to the multicast information registration request message of the step S430, at step S440.

Accordingly, the multicast source 500 transmits a multicast stream to the HCA#3 300-3 of the access network to which the multicast source 500 belongs, at step S450. The HCA#3 300-3 transmits the multicast stream to the HCA#1 300-1 of the access network to which the MN 100-1 belongs, through the multicast path set at the step S425, at step S455. The HCA#1 300-1 transmits the multicast stream to the MN 100-1 through the PoA#1 200-1 at step S460.

Hereinafter, the structure of a binding table in which the multicast information is registered at the step S435 will be described with reference to FIG. 6.

As described with reference to FIG. 4, when the MN 100-1 completes the initial registration in the network at the step S405 and transmits the multicast information report message to the HCA#1 300-1 at the step S415, the HCA#1 300-1 transmits the multicast information S and G of the MN 100-1 to the MICS 400 at the step S430. The MICS 400 receiving the message of the step S430 registers the corresponding multicast information S and G by referring to the identifier of the MN 100-1 in the table storing the information of the MN 100-1, at step S435. The identifier of the MN 100-1 may include an L2 address of the MN 100-1, for example.

The step S435 may be performed by using a table of FIG. 6 which is obtained by adding a ‘Multicast(S,G)’ field 625 to the GLMT for the MN 100-1 managed by the MICS 400. The table of FIG. 6 includes ‘HoA (Home of Address)’ field 610, ‘CoA (Care of Address)’ field 615, ‘L2 Lists’ field 620, and ‘Multicast(S,G)’ field 625. In the able of FIG. 6, ‘No’ field 605 indicates the index of a record. The HoA field 610 stores the PA information of the corresponding MN, the CoA field 615 stores the LA information of the corresponding MN, and the L2 Lists field 620 stores the L2 address of the corresponding MN. The MICS 400 receiving the message of the step S430 stores the multicast information S and G of the MN 100-1 in the Multicast(S,G) field 625, by referring to the L2 address which is the identifier of the MN 100-1.

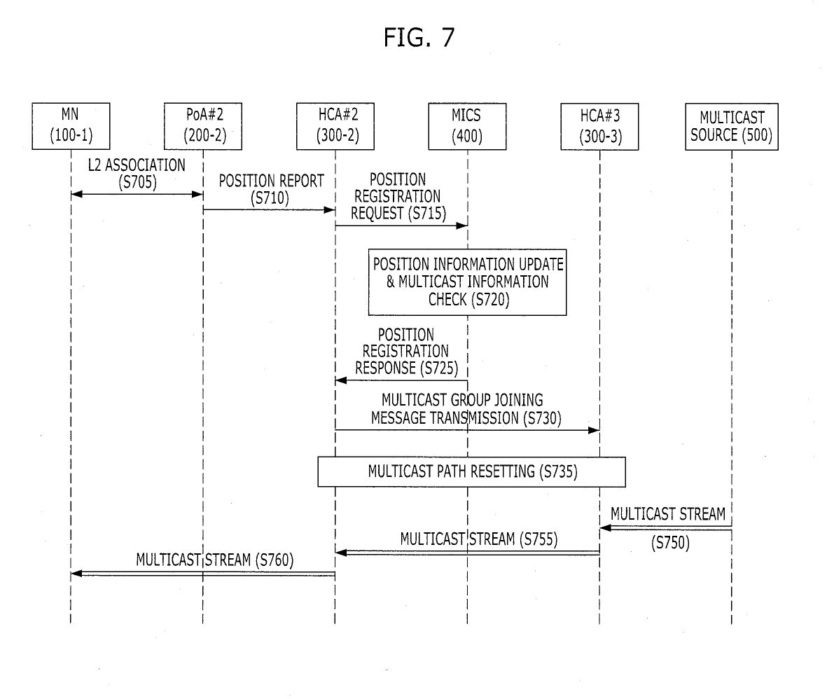

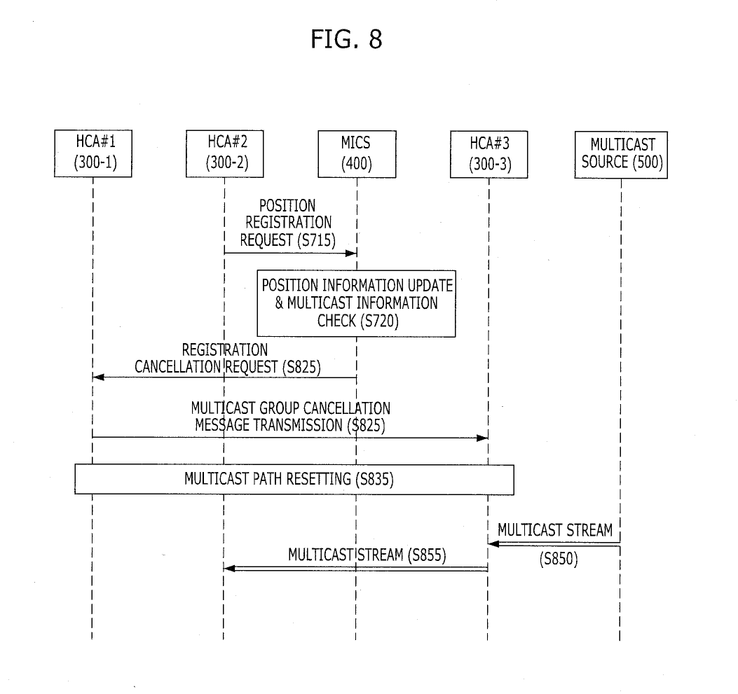

During a handover of the MN 100-1, when an update of the position information of the MN 100-1 is requested from an HCA, the MICS 400 checks whether the multicast information S and G exists or not, by referring to the L2 address which is the identifier of the MN 100-1. When the multicast information S and G exists, the MICS 400 may transmit the multicast information S and G to the HCA such that a new multicast path for the MN 100-1 is formed. This will be described below with reference to FIGS. 7 and 8.

FIG. 7 is a diagram explaining a multicast group rejoining procedure during a handover of the MN 100-1 to another access network (for example, the access network #2). Referring to FIG. 7, the MN 100-1 having moved from the access network #1 to the access network #2 performs L2 association through an L2 association request and a response to the request, in order to set a wireless channel with the PoA#2 200-2, at step S705. Meanwhile, the PoA#2 200-2 transmits the position information of the MN 100-1 (for example, L2 address) to the HCA#2 300-2 to which the PoA#2 200-2 belongs, using a position report message, at step S710. The HCA#2 300-2 transmits the identifier of the MN 100-1 (for example, L2 address), the LA of the MN 100-1, and the address of the HCA#2 300-2 (for example, L3 address) to the MICS 400, using a position registration request message, at step S715. The MICS 400 updates the position information of the MN 100-1 in the table for managing the information of the MN (for example, the GMLT of FIG. 6) and checks whether the multicast information S and G of the MN 100-1 exists or not, using the position registration request message received from the HCA#2 300-2, at step S720. When the multicast information S and G of the MN 100-1 performing the position registration exists, the MICS 400 transmits the multicast information S and G of the MN 100-1 in response, at step S725. During the response of the step S725, the identifier of the MN 100-1 may be transmitted together with the multicast information S and G, in order to notify that the multicast information S and G is the multicast information S and G of the MN 100-1. The HCA#2 300-2 transmits and receives a message to and from an adjacent HCA according to a predetermined protocol as in the multicast group joining procedure of FIG. 4, based on the multicast information S and G of the MN node 100-1 received from the MICS 400, and a multicast path between the multicast source 500 and the MN 100-1 having moved to the access network #2 is reset between the corresponding HCAs, at steps S730 and S735. For example, the HCA#2 300-2 transmits a PIM-SSM subscribe message containing the multicast information of the MN 100-1 to the adjacent HCA at the step S730, and an optimal path is set between the corresponding HCAs according to an algorithm defined in the PIM protocol at the step S735.

Therefore, the multicast source 500 transmits a multicast stream to the HCA#3 300-3 of the access network to which the multicast source 500 belongs at step S750. The HCA#3 300-3 transmits the multicast stream to the HCA#2 300-2 of the access network #2 to which the MN 100-1 belongs, through the multicast path reset at the step S735, at step S755. The HCA#2 300-2 transmits the multicast stream to the MN 100-1 through the PoA#2 200-2 at step S760.

FIG. 8 is a diagram explaining a procedure for canceling the multicast path set by the HCA#1 300-1, during a handover of the MN 100-1 from the access network #1 to the access network #2. As described with reference to FIG. 7, when the HCA#2 300-2 transmits a position registration request message for the MN 100-1 to the MICS 400 at step S715, the MICS 400 updates the position information of the MN 100-1 in the table for managing the information of the MN 100-1, for example, the GMLT of FIG. 6, and checks whether the multicast information S and G of the MN 100-1 exists or not, at step S720. When the multicast information S and G of the MN 100-1 exists, the MICS 400 transmits a registration cancellation request message to the HCA#1 300-1, using the information of the access network to which the MN 100-1 was previously connected (for example, the L3 address of the HCA where the MN is positioned), at step S825. At this time, the registration cancellation request message includes the identifier of the MN 100-1 (for example, L2 address) and the multicast information S and G of the MN 100-1. The HCA#1 300-1 receiving the registration cancellation request message determines that the MN 100-1 does not exist in the access network #1, transmits and receives a message to and from an adjacent agent according to a predetermined protocol based on the registration cancellation request message, and cancels the previous multicast path between the multicast source 500 and the MN 100-1 to reset the path for the corresponding multicast group between the agents, at step S830 and S835. For example, the HCA#1 300-1 transmits a PIM-SSM unsubscribe message containing the multicast information of the MN 100-1 to an adjacent HCA at step S830, and an optimal path is reset between the corresponding HCAs according to an algorithm defined in the PIM protocol at step S835. When the group cancellation procedure in the previous access network is not performed after the MN 1001 moved to a new access network, the multicast path may be continuously maintained. In this case, unnecessary data transmission may occur. Therefore, the group cancellation procedure is performed to prevent the unnecessary data transmission.

Therefore, the multicast source 500 does not transmit the multicast stream to the access network #1 where the MN 100-1 was positioned before movement. That is, the multicast source 500 transmits the multicast stream to the HCA#3 300-3 of the access network to which the multicast source 500 belongs, at step S850. The HCA#3 300-3 transmits the multicast stream to the HCA#2 300-2 of the access network #2 to which the MN 100-1 belongs, through the multicast path reset at the step S835, at step S855. The HCA#2 300-2 transmits the multicast stream to the MN 100-1 through the PoA#2 200-2.

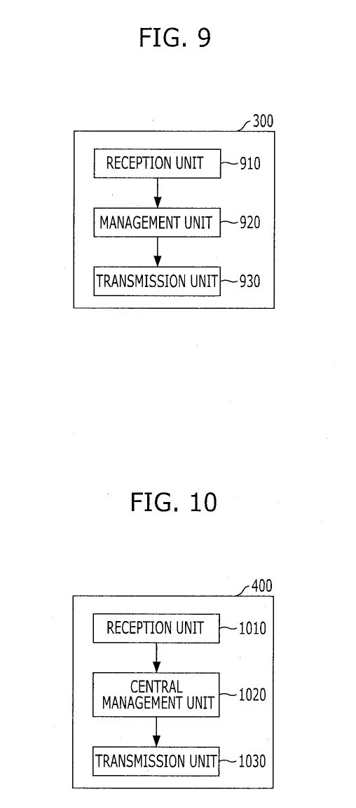

Hereinafter, the configurations of the HCA 300 and the MICS 400 in the mobile communication system implemented according to the above-described method will be described with reference to FIGS. 9 and 10, respectively. Here, duplicated descriptions will be omitted.

Referring to FIG. 9, the HCA 300 includes a reception unit 910, a management unit 920, and a transmission unit 930. The reception unit 910 is configured to receive a necessary message according to the above-described method, and the transmission unit 930 is configured to transmit a necessary message according to the above-described method. The management unit 920 is configured to process the message received by the reception unit 910 and the message to be transmitted by the transmission unit 930 according to the above-described method.

Referring to FIG. 100, the MICS 400 includes a reception unit 1010, a central management unit 1020, and a transmission unit 1030. The reception unit 1010 is configured to receive a necessary message according to the above-described method, and the transmission unit 1030 is configured to transmit a necessary message according to the above-described method. The central management unit 1020 is configured to process the message received by the reception unit 1010 and the message to be transmitted by the transmission unit 1030 according to the above-described method.

In accordance with the embodiments of the present invention, as the multicast information of an MN is managed by a network, a group rejoining process may be omitted during the occurrence of a handover. Therefore, it is possible to improve the processing delay problem.

While the present invention has been described with respect to the specific embodiments, it will be apparent to those skilled in the art that various changes and modifications may be made without departing from the spirit and scope of the invention as defined in the following claims.

What is claimed is:

1. A method for providing a multicast service for a mobile node (MN) in a mobile communication system including a plurality of access networks, a plurality of agents for the respective access networks which connect a core network unifying the access networks, and a mobility information control server (MICS) positioned in the core network and configured to manage the plurality of access networks, the method comprising:
transmitting, by an MN connected to a first access point within a first access network, multicast information of the MN to an agent of the first access network through the first access point, wherein the multicast information comprises information on a multicast source and a multicast group;
transmitting and receiving messages between agents according to a predetermined protocol based on the multicast information of the MN transmitted to the agent of the first access network, and setting a multicast path between the multicast source and the MN of the first access network between the agents;
transmitting, by the agent of the first access network, the multicast information of the MN to the MICS; and
registering, by the MICS, the multicast information of the MN transmitted from the agent of the first network.

2. The method of claim 1, wherein the multicast information comprises information on a multicast service which the MN selects from information on available services received from a service directory.

3. The method of claim 1, wherein, in said registering, by the MICS, the multicast information of the MN transmitted from the agent of the first network, an identifier of the MN and the information on the multicast source and the multicast group are stored.

4. The method of claim 1, further comprising:
when the MN moves from the first access network to a second network, transmitting, by a second access point of the second network to which the MN is connected, position information of the MN to an agent of the second network;
transmitting, by the agent of the second access network, the position information of the MN and an address of the agent of the second access network to the MICS;
updating, by the MICS, the previously-registered position information of the MN and extracting the registered multicast information of the MN, using the position information of the MN and the address of the agent of the second access network which are received from the agent of the second access network;
transmitting, by the MICS, the extracted multicast information of the MN to the agent of the second access network; and
transmitting and receiving messages between the agents according to a predetermined protocol based on the multicast information of the MN transmitted to the agent of the second network, and resetting a multicast path between the multicast source and the MN having moved to the second access network between the agents.

5. The method of claim 4, further comprising:
transmitting, by the MICS, transmitting a multicast group cancellation request message for the MN at the position before movement to the agent of the first access network, using the extracted multicast information of the MN; and
transmitting and receiving messages between the agents according to a predetermined protocol based on the group cancellation request message transmitted to the agent of the first access network, canceling the multicast path between the multicast source and the MN at the position before movement, and resetting the multicast path for the multicast group.

6. A method for providing a multicast service for an MN in a mobile communication system including a plurality of access networks, a plurality of agents for the respective access networks which connect a core network unifying the access networks, and an MICS positioned in the core network and configured to manage the plurality of access networks, the method comprising:
receiving multicast information of an MN, which is transmitted from the MN connected to a first access point within a first access network through the first access point to an agent of the first access network, from the agent of the first access network, wherein the multicast information comprises information on a multicast source and a multicast group;
registering the multicast information of the MN received from the agent of the first access network;
when the MN moves from the first access network to a second access network, receiving position information of the MN, which is transmitted to an agent of the second access network from a second access point of the second access network to which the MN is connected, and an address of the agent of the second access network from the agent of the second access network;
updating previously-registered position information of the MN using the position information of the MN and the address of the agent of the second access network, which are received from the agent of the second access network, and extracting the registered multicast information of the MN; and
transmitting and receiving messages between the agents according to a predetermined protocol based on the extracted multicast information of the MN, and transmitting the extracted multicast information of the MN to the agent of the second access network to reset a multicast path between the multicast source and the MN having moved to the second access network.

7. The method of claim 6, wherein the multicast information comprises information on a multicast service which the MN selects from information on available services received from a service directory.

8. The method of claim 6, wherein, in said registering the multicast information of the MN received from the agent of the first access network, an identifier of the MN and the information on the multicast source and the multicast group are stored.

9. The method of claim 6, further comprising transmitting and receiving messages between the agents according to a predetermined protocol based on a multicast group cancellation request message, and transmitting the multicast group cancellation request message for the MN at the position before movement to the agent of the first access network using the extracted multicast information of the MN such that the multicast path between the multicast source and the MN at the position before movement is canceled and the multicast path for the multicast group is reset.

10. An agent of any one access network for providing a multicast service for an MN in a mobile communication system including a plurality of access networks, a plurality of agents for the respective access networks which connect a core network unifying the access networks, and an MICS positioned in the core network and configured to manage the plurality of access networks, the agent comprising:
a reception unit configured to receive multicast information of an MN connected to an access point within the access network through the access point from the MN, wherein the multicast information comprises information on a multicast source and a multicast group;
a management unit configured to set a multicast path between the multicast source and the MN of the access network between agents, through transmission and reception of messages between the agents according to a predetermined protocol based on the received multicast information of the MN; and
a transmission unit configured to transmit the multicast information of the MN to the MICS such that the multicast information is registered in the MICS,
wherein the transmission unit transmits one or more messages, which are required for setting the multicast path between the agents through the MICS, to another or more agents, and
the reception unit receives one or more messages, which are required for setting the multicast path between the agents through the MICS, from another or more agents.

11. The agent of claim 10, wherein the multicast information comprises information on a multicast service which the MN selects from information on available services received from a service directory.

12. The agent of claim 10, wherein, when the MN moves from another access point, the reception unit receives position information of the MN from the access point to which the MN is connected,
the transmission unit transmits the position information of the MN received by the reception unit and the address of the agent of the access network to which the MN belongs to the MICS such that the MICS updates previously-registered position information of the MN and extracts the registered multicast information of the MN, using the position information of the MN and the address of the agent of the access network to which the MN belongs,
the reception unit receives the multicast information of the MN extracted by the MICS from the MICS, and
the management unit resets a multicast path between the multicast source and the MN having moved from the another access network between the agents, through transmission and reception of messages between the agents according to a predetermined protocol based on the multicast information of the MN received from the MICS.

13. The agent of claim 10, wherein, when the MN moves to another access network, the reception unit receives a multicast group cancellation request message for the MN from the MICS, and
the management unit cancels a multicast path between the multicast source and the MN at a position before movement and resets a multicast path for the multicast group, through transmission and reception of messages between the agents according to a predetermined protocol based on the multicast group cancellation request message received by the reception unit.

14. An MICS providing a multicast service for an MN in a mobile communication system including a plurality of access networks, a plurality of agents for the respective access networks which connect a core network unifying the access networks, and the MICS positioned in the core network and configured to manage the plurality of access networks, the MICS comprising:
a reception unit configured to receive multicast information of an MN, which is transmitted from the MN connected to a first access point within a first access network through the first access point to an agent of the first access network, from the agent of the first access network, wherein the multicast information comprises information on a multicast source and a multicast group;
a central management unit configured to register the multicast information of the MN received from the agent of the first access network; and
a transmission unit,
wherein when the MN moves from the first access network to a second access network, the reception unit receives position information of the MN, which is transmitted to an agent of the second access network from a second access point of the second access network to which the MN is connected, and an address of the agent of the second access network from the agent of the second network,
the central management unit updates previously-registered position information of the MN and extracts the registered multicast information of the MN, using the position information of the MN and the address of the agent of the second access network which are received from the agent of the second access network, and
the transmission unit transmits the extracted multicast information of the MN to the agent of the second access network such that a multicast path between the multicast source and the MN having moved to the second access network is reset between the agents, through transmission and reception of messages between the agents according to a predetermined protocol based on the extracted multicast information of the MN.

15. The MICS of claim 14, wherein the multicast information comprises information on a multicast service which the MN selects from information on available services received from a service directory.

16. The MICS of claim 14, wherein the central management unit registers the multicast information of the MN by storing an identifier of the MN and the information on the multicast source and the multicast group.

17. The MICS of claim 14, wherein the transmission unit transmits a multicast group cancellation request message for the MN at the MN at a position before movement to the agent of the first access network using the extracted multicast information of the MN such that the multicast path between the multicast source and the MN at the position before movement is canceled and the multicast path for the multicast group is reset, through transmission and reception of messages between the agents according to a predetermined protocol based on the multicast group cancellation request message.
